(19) United States
(12) Patent Application Publication
(10) Pub. No.: US 2011/0033089 A1
(43) Pub. Date: Feb. 10, 2011

(54) APPARATUS FOR APPRAISING THE GENUINENESS OF PERSONAL IDENTIFICATION DOCUMENTS

(76) Inventor: Kazuaki YOKOTA, Tokyo (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/851,741

(22) Filed: Aug. 6, 2010

(30) Foreign Application Priority Data
Aug. 6, 2009 (JP) P2009-183158

(51) Int. Cl. G06K 9/00

(52) U.S. Cl. 382/112

(57) ABSTRACT

An apparatus for appraising the genuineness of personal identification documents is provided with: an image reading section that reads an image of a personal identification document; an extraction section that extracts a monochromatic filled region from the image read by the image reading section; and a decision section that decides that the personal identification document is forged if a specified image pattern is present in the monochromatic filled region extracted by the extraction section, and that decides that a personal identification document is not forged if the specified image pattern is not present in the filled region.

### CROSS-REFERENCE TO RELATED APPLICATION

This application claims benefit of priority from Japanese application number JP2009-183158 filed Aug. 6, 2009; the entire contents of which are incorporated by reference herein.

### FIELD

Embodiments described herein relate generally to apparatus for appraising the genuineness of personal identification documents that appraises the genuineness of personal identification documents such as a driving license or health insurance card presented by an applicant when making a contract at the counter of for example a financial institution or communication company.

### BACKGROUND

By the enactment of the Personal Identification Law in Japan, the duty has been imposed on financial institutions and mobile telephone carriers etc of confirming the personal identity of contractees. Cases of attempting to circumvent this law by forgery of driving licenses etc are increasing. Previously, extremely expensive equipment was required in order to perform such forgery of a driving license.

Currently, due to improvements in the performance of computers/printers/scanners etc, anybody can easily create a forged driving license capable of being mistaken for the genuine article at first glance.

Such forged documents that can easily be created using a computer/printer/scanner etc are of a quality that can be distinguished from the genuine article if the checker takes care, in that the quality of the paper differs from that of the genuine article and that the ink runs on wetting etc.

However, at the counter of for example a financial institution or mobile telephone company, it is necessary for the person responsible to compare the details of a contract accepted by the contractee with the personal identification documents handed over by the contractee himself and return these in a short time, so the task of confirming the personal identification documents by the person responsible becomes complex and there is thus a possibility of forged identification cards being overlooked.

In order to prevent this, recently, in Japan, in order to prevent forgery of personal identification documents, IC chip-embedded personal identification cards (for example, the basic resident register card or, from 2007 onwards, driving licenses in the form of an IC card) have been issued. The genuineness of such personal identification cards in the form of IC cards can easily be appraised by reading by an IC card reader.

However, with such IC card readers, a password of several digits is required in order to protect individual information. Consequently, in order to handle such personal identification cards at the reception counter, it is necessary to introduce new terminals equipped with an IC card reader and keyboard: this presented the problem of necessitating considerable investment.

Also, IC cards have been created that stop functioning after several attempts to input the correct password. For example in the case of a driving license, the password is only infrequently used, so there is a risk that the user himself may disable functioning by erroneous input: thus such card identification equipment has not been implemented at many reception counters.

A known technique using an inexpensive construction for identifying forged papers that have been copied using a color copier is for example the technique of distinguishing between a genuine note and forged note (obtained by color copying of a genuine note) by detecting surface irregularity information of the printing ink in the surface of the paper.

However, in the case of the above technique, as a surface regularity detection section for detecting surface irregularity information of the printing ink, it is necessary to employ special hardware in addition to a computer (i.e. a responsive element that produces changes in charge corresponding to the surface irregularity): thus, there is the problem that investment in special equipment is required, just as in the case of employing an IC card.

In order to solve the above problem, apparatus for appraising the genuineness of personal identification documents comprises the following construction. Specifically, apparatus for appraising the genuineness of personal identification documents is characterized in that it comprises:

an image reading section that reads an image of a personal identification document;

an extraction section that extracts a monochromatic filled region from the aforementioned image read by the aforementioned image reading section; and

a decision section that decides that, if a specified image pattern is present in the aforesaid monochromatic filled region extracted by the aforesaid extraction section, the aforesaid personal identification document is forged, and that decides that a personal identification document as aforesaid in which the aforesaid specified image pattern is not present in the aforesaid filled region is not forged i.e. is genuine.

### BRIEF DESCRIPTION OF THE DRAWINGS

FIG. 1 is a view showing the layout of apparatus for appraising genuineness of a personal identification document according to an embodiment;

FIG. 2 is a view showing an image printed with grey color by an inexpensive printer, and the appearance of a portion thereof to a larger scale;

FIG. 3 is a view to a larger scale of part of a scanned image obtained by scanning a forged driving license created for example by sticking a copied photograph onto a driving license, and the background portion of the photograph thereof;

FIG. 4 is a flow chart showing the action of appraising genuineness in respect of a driving license performed by the personal identification document appraising apparatus;

FIG. 5 is a flow chart showing the action of appraising genuineness in respect of a health insurance card;

FIG. 6 is a view to a larger scale showing Moir̂ e stripes produced in the thick-line parts of a forged health insurance card produced by scanning a health insurance card and printing by an inkjet printer;

FIG. 7 is a view showing images obtained by color separation into blue, red and green of the image of the photograph portion of a forged document;

FIG. 8 is a view showing a color image of the background portion of a driving license in Japan; and

FIG. 9 is a view showing a blue image obtained by color separation of the color image of FIG. 8.

### DETAILED DESCRIPTION

According to the present technology an apparatus for appraising the genuineness of personal identification documents is constructed as follows: specifically, an apparatus for appraising the genuineness of personal identification documents is provided with: an image reading section that reads an image of a personal identification document; an extraction section that extracts a monochromatic filled region from the image read by the image reading section; and a decision section that decides that the personal identification document is forged if a specified image pattern is present in the monochromatic filled region extracted by the extraction section, and that decides that a personal identification document is not forged if the specified image pattern is not present in the filled region.

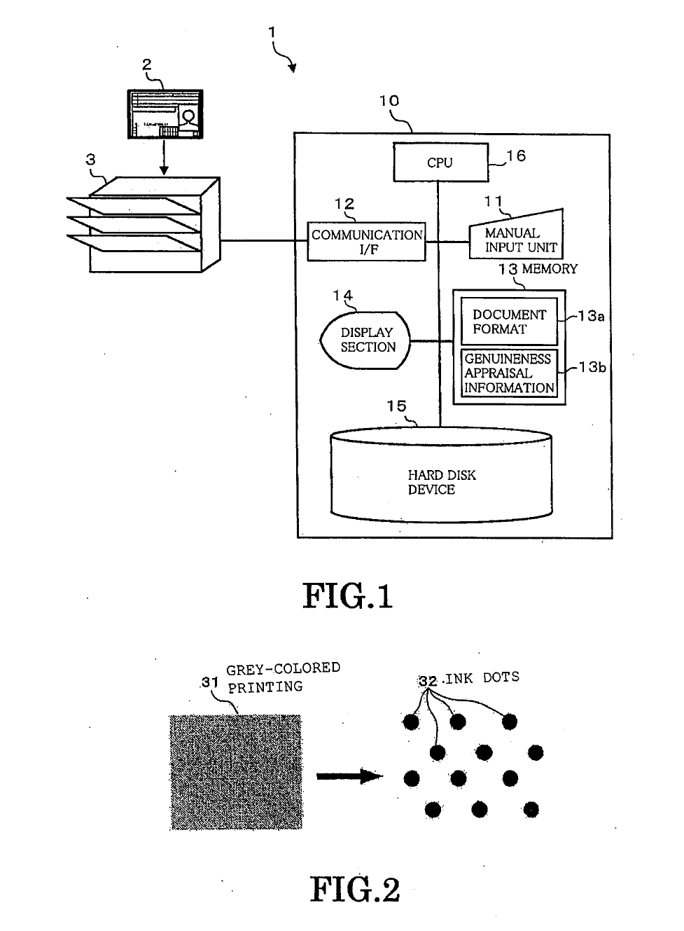

One embodiment of an apparatus for appraising genuineness of a person identification document is described in detail below with a reference to the drawings. FIG. 1 is a view showing the layout of this apparatus for appraising genuineness of a personal identification document (or identity verification document).

As shown in FIG. 1, the apparatus 1 for appraising genuineness of a personal identification document according to this embodiment comprises: an image scanner 3 (hereinafter referred to as a scanner 3) that acquires (generates) image information (image data) by scanning, using for example a CCD (charge coupled device), the surface of a driving license 2 in Japan (hereinafter referred to as “license 2”) constituting a personal identification document, and a computer 10 connected with this scanner 3 and that detects the presence of Moiré stripes (Moiré pattern or Moiré fringes) from the image obtained by extracting an image of a monochromatic filled region such as the background portion 33 of the photograph from the image (image data) read from the license 2.

(Principles of Generation of Moiré Stripes)

In printing using an inkjet printer, halftone dots are employed in order to achieve a graded representation (or gradation expression) of portions of a photograph. Specifically, in an inkjet printer, the depth of color is represented by the respective magnitudes of regularly arranged dots. Consequently, in a color photograph printed with an inkjet printer, printing is effected by superimposing halftone dots of a plurality of colors, with the result that a periodic color pattern can be seen, producing Moiré stripes. Moiré stripes are produced as a result of difference in resolution between a photograph printed with halftone dots and the scanner. Consequently, when a genuine license 2 is read by the scanner 3, Moiré stripes are not produced, since no halftone dots are present.

The scanner 3 acquires a color image (image data) by using a CCD sensor to scan the surface of the license 2 and this image is input to the computer 10. The computer 10 extracts an image of the monochromatic filled region from the input image.

In other words, the scanner 3 functions as an image acquisition section that acquires an image of a personal identification document. It is assumed that the read resolution of the scanner 3 is set at for example 600 dpi.

The computer 10 includes a manual input unit 11, communication I/F (interface) 12, and memory 13 constituting a storage section, a display section 14, hard disk device 15 and the CPU (Central Processing Unit) 16. The manual input unit 11 constitutes input means whereby the user can perform control actions and may include for example a keyboard and mouse. The communication I/F 12 is provided in the computer and is an interface for connection of external equipment including a USB (universal serial bus) port for connecting for example USB connectable equipment with the computer 10.

The memory 13 stores the document format 13a and genuineness appraisal information 13b for detecting the region of the license 2 and the region of the photograph portion therein from the image.

The document format 13a is document format information for detecting from the image obtained by the scanner 3 for example the position and inclination of the outer frame of the personal identification document such as a license 2 or health insurance card 5 and for extracting the monochromatic filled region in this detected image, and may be assumed to be set for each type of document.

Regarding the manner of appraising the type of personal identification document in question i.e. whether this is a license 2 or a health insurance card 5, this may be achieved either by designating the type of document from the manual input unit 11 when the document is read, or by reading the characteristic features of the document from the image of the document. Also, if it is arranged beforehand that the document to be processed should be of one type only, format information relating solely to the type of document in question may be arranged to be utilized.

In the document format 13a, there are set the frame of the license 2 and/or the portion where the photograph is stuck on and/or the blue-colored background region (specification information specifying the extraction area of the monochromatic filled region) where there is no photograph of a person, taking the information of the extraction region, of the image obtained from the scanner 3, as being information for which (the positional coordinates at the top left hand corner of the entire image are X coordinate: 0, Y coordinate: 0).

As the information 13b for appraising genuineness, there are stored range data or threshold value data for appraising whether the values (frequency components) obtained by performing Fourier transformation on the monochromatic filled region (for example the blue-colored background portion in the license 2 or the thick-lined part enclosing the name of the document in the health insurance card 5) constitute Moiré stripes.

It should be noted that, since characteristic characters are printed at several locations in specified positions on for example a license 2, by storing the external shape or photograph portion of the license 2 with reference to the positions of these respective characters (coordinates and distance data between the characters etc), and the positional coordinates of the blue-colored background portion (monochromatic filled region) in this photograph, the external shape, photograph portion and blue-colored background portion (monochromatic filled region) of the license 2 could be specified.

The display section 14 displays for example an information screen and information message etc of the result of the determination as to whether or not Moiré stripes are present (i.e. the result of the appraisal of genuineness) obtained from the image of the personal identification document or the extracted image of part thereof that is acquired by the scanner 3.

On the hard disk device 15 there is installed an operating system (hereinafter turned OS) and control program (software) for performing control operation of the various sections by the CPU 16: the operation of the present system is implemented by co-operation of these. This operation will be described in terms of operation of the CPU 16 after startup of the computer.

Specifically, the CPU 16 functions as a determination section that extracts the monochromatic filled region (in the case of a license 2, the background portion of the photograph) from the image of the personal identification document acquired by the scanner 3, determines whether or not an image pattern (Moiré stripes) is present at a prescribed pattern position in the monochromatic filled region thereof, and, if the image pattern is present at the prescribed pattern position, decides that this personal identification document is a forged document; and if this pattern image is not present, decides that this personal identification document is not forged (i.e. is a genuine personal identification document).

Also, the CPU 16 functions as a determination section that extracts the monochromatic filled region from the color image of the personal identification document acquired by the scanner 3 and separates this monochromatic filled region into images of different colors (R, G and B) and, at first a specified image pattern (pattern of sparse points) is present or not, that is to say, that decides that a personal identification document is a forged document if the specified image pattern is present in an image of any of the separated colors, and that decides that the personal identification document is not a forged document (i.e. is genuine) if the specified pattern is not present.

If the CPU 16 determines that the document is a forgery, it reports this by outputting a message indicating forgery to the display section 14. Also, if the CPU 16 determines that the document is genuine, it reports this by outputting a message indicating a genuine document to the display section 14.

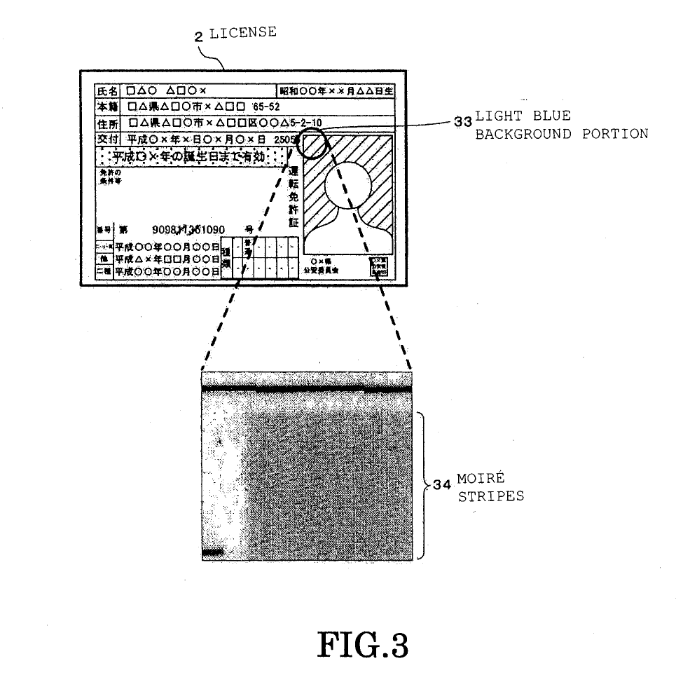

The principles of the appraisal of genuineness of personal identification documents will now be described with reference to FIG. 2 and FIG. 3.

Generally marketed inexpensive printers (such as laser printers or inkjet printers) perform printing using inks of a small number of colors, such as red, cyan, green and black. Consequently, in order to realize for example a light grey color, rather than making the ink itself thin, printing is performed with a reduced number of ink dots.

Consequently, as shown in FIG. 2, with an inexpensive printer as described above, when a region 31 in which a grey color is printed is magnified, it can be seen that small black ink dots 32 are printed arranged at minute intervals (for example an interval of about 1/100 mm). Since human beings cannot recognize such assemblies of fine dots, the ink dots 32 appear mixed with the white color of the background of the paper and such printing is perceived as a grey color.

As shown in FIG. 3, when a location that is filled with the same color (monochromatically), such as the blue-colored background portion 33 of the photograph printed on the license 2, is considerably magnified, a stripe pattern called Moiré stripes 34 appears. Since a genuine license 2 is produced by for example screen-printing, such a stripe pattern cannot appear. Accordingly, with this apparatus, a license 2 can easily be identified as a forgery by detecting the Moiré stripes from the image of the license.

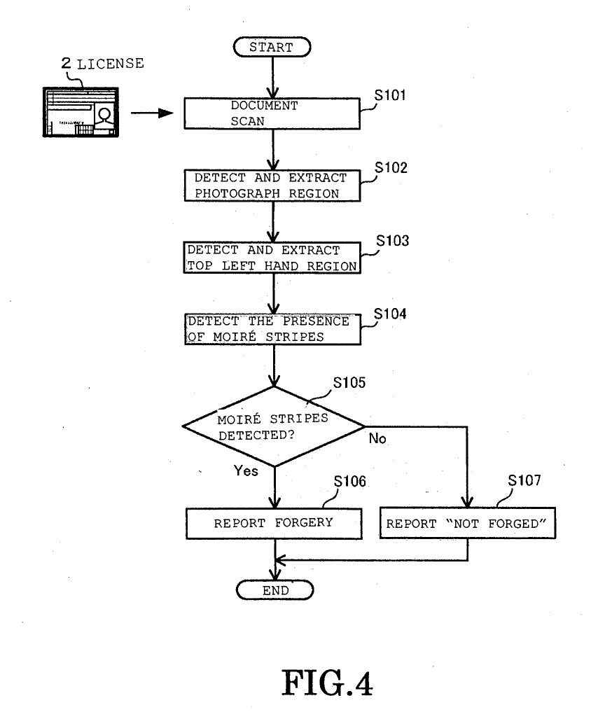

The operation of this personal identification document genuineness appraisal apparatus 1 will now be described with reference to the flow chart of FIG. 4. In this person identification document genuineness appraisal apparatus (sometimes called the apparatus for appraising the genuineness of personal identification documents) 1, the license 2 is scanned by the scanner 3 (step S101 in FIG. 4) and an image thereof is input to the computer 10: the CPU 16 then temporarily stores this image in the memory 13.

Next, the CPU 16 reads the document format 13a and the image from the memory 13 and detects the photograph region from the document format 13a and extracts this photograph region from the image (step S102).

Next, the CPU 16, from this extracted photograph region, extracts (step S103) the image of the blue-colored background portion at the top left, which is the extraction region (monochromatic filled region) that is specified in the document format 13a.

The CPU 16, by Fourier transformation of the image of the blue-colored background portion that was extracted, finds the frequency components, and detects the presence of Moiré stripes by comparing these values with genuineness appraisal information 13b that is preset in the memory 13 (step S104). If for example the frequency component value exceeds a prescribed threshold value (genuineness appraisal information 13b), the CPU 16 detects the presence of Moiré stripes.

If the CPU 16 detects the presence of Moiré stripes (Yes in step S105), it reports that the license 2 is a forged document (step S106). Also if the CPU 16 finds that the frequency component value is below a prescribed threshold value (genuineness appraisal information 13b), this is deemed to indicate that Moiré stripes have not been detected (No in step S105), and the CPU reports (step S107) that the license 2 is not a forged document (i.e. is genuine).

Regarding the method of reporting, the method may be adopted of for example generating a message such as “forgery” or “genuine” on the display section 14. In addition, in the case of a “forgery”, this may merely be indicated by sounding a buzzer incorporated in the computer 1.

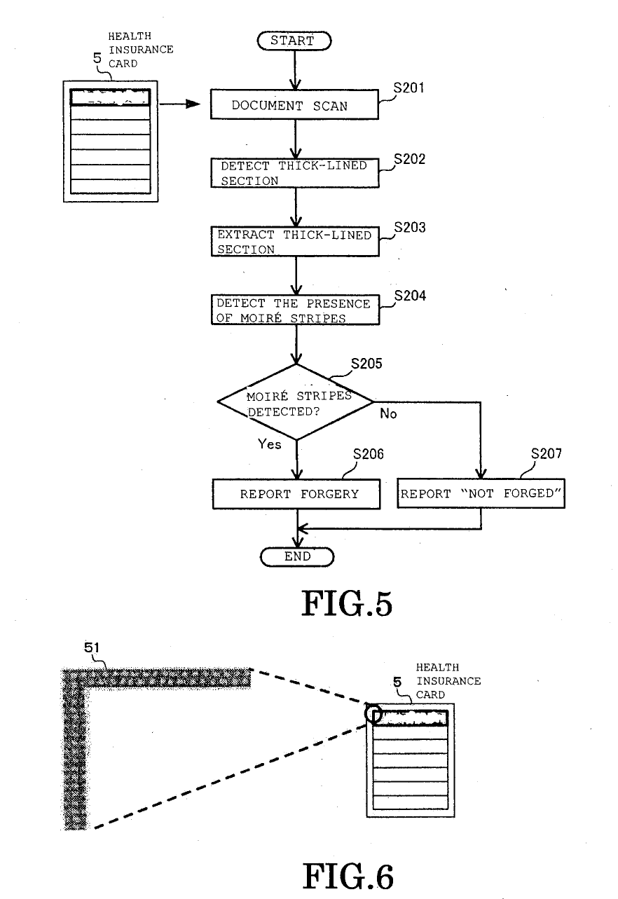

Next, the operation of appraising genuineness of a health-insurance card 5 by the personal identification document genuineness appraisal apparatus (the apparatus for appraising the genuineness of personal identification documents) 1 will be described with reference to FIG. 5 and FIG. 6. In the case of a health-insurance card 5, the frame of the name column of this health-insurance card is printed with considerable thickness, so that a filled region of a fixed width and height or more is present. Accordingly, in this operating example, this thick-line section of the health insurance card 5 is utilized for appraising genuineness.

In this case, when the health insurance card 5 is scanned by the scanner 3 (step S201 in FIG. 5), and its image is input to the computer 1, the CPU 16 temporarily stores this image in the memory 13.

Next, the CPU 16 reads the document format 13a and the image from the memory 13 and detects (step S202) the region of the thick-lined section from the document format 13a, and extracts (step S203) an image 51 (see FIG. 6) of the thick-line section at the left-hand corner, which is the extraction region (monochromatic filled region) that is defined in the document format 13a.

The CPU 16 finds the frequency component by Fourier transformation of the image 51 of the thick-line section region (or the region of the thick-lined section) that has been extracted and detects the presence of Moiré stripes (step S204) by comparing this value with the genuineness appraisal information 13b that is set beforehand in the memory 13. For example, if the value of the frequency component exceeds a prescribed threshold value (genuineness appraisal information 13b), the CPU 16 detects (appraises) the presence of Moiré stripes.

If the CPU 16 detects (appraises) the presence of Moiré stripes (Yes in step S205), it reports that the health insurance card 5 is a forged document (step S206).

Also if the CPU 16 finds that the frequency component value is below a prescribed threshold value (genuineness appraisal information 13b), this is deemed to indicate that Moiré stripes have not been detected (No in step S205), and the CPU reports (step S207) that the health insurance card 5 is not a forged document (i.e. is genuine).

It should be noted that, by using the same principles, it would be possible to extract for example a band-shaped region present in the validity term column of a license as described above, not just in the health insurance card 5, and to determine the genuineness of the license 2 by detecting the presence of Moiré stripes.

In this way, with the personal identification document genuineness appraisal apparatus (the apparatus for appraising the genuineness of personal identification documents) 1 according to this embodiment, by an inexpensive hardware construction employing a computer and scanner, for example appraising the genuineness of a personal identification document such as a license 2 or health insurance card 5 can be easily performed.

It should be noted that the present apparatus has the drawback of being incapable of detecting a forged driving license forged using equipment that is comparatively expensive, such as a phototype process. However, the numbers of such expensive equipment shipped are small, so the labor involved in tracing such equipment is comparatively small.

However, forgery using a scanner and printer, in comparison, can be achieved by a smaller scale operation and is frequently carried out by large numbers of criminals and so requires considerable effort to trace. The present apparatus can effectively deal with this large number of small-scale crimes and its introduction may therefore be said to have considerable benefit even though the apparatus is inexpensive.

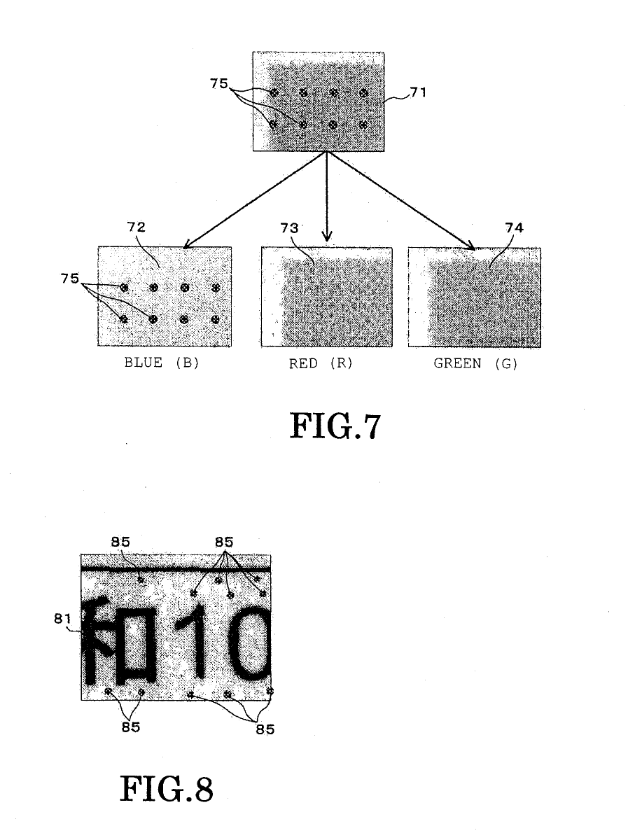

Next, an example of application of the personal identification document genuineness appraisal apparatus (the apparatus for appraising the genuineness of personal identification documents) will be described with reference to FIG. 7. In this application example, the photograph region of a license 2 is employed. As shown in FIG. 7, an image of a license 2 is constituted by a color image; the background image 71, which is the part of the photograph region of this license 2 that does not contain the person, is of blue color i.e. is a monochromatic filled region.

In this example, the CPU 16 separates, from the blue-colored background image 71 which is the color image, a blue-colored image (B) 72 of the blue-colored component, a red-colored image (R) 73 of the red-colored component, and a green-colored image (G) 74 of the green-colored component, respectively; of these, it extracts an image i.e. the blue-colored image 72 that approximates to the background color, and detects the presence of a pattern showing the characteristic features of forgery by a color printer in respect of this extracted blue-colored image 72.

The background of the photograph of the license 2 is blue. If this color were a perfectly blue color, the image 72 obtained by separation into blue color (B) would be the same as when viewed with blue spectacles i.e. would appear completely white.

However, since the color of the forgery (forged license) created by copying an actual license 2 is not completely blue, components of other colors (green and red) are also included in the separated blue-colored image 72, albeit in small amounts. These small-quantity green and red components are printed as a pattern in which dots 75 are present in sparse fashion (this is called a “sparse dot pattern”, “pattern of sparse points” or “pattern of sparse dots”) by a laser printer or inkjet printer.

Consequently, as shown in FIG. 7, a pattern of sparse dots 75 appears in the blue-colored image 72 extracted by color separation from the image of the forged license. Such a pattern does not appear when a genuine license 2 is scanned.

In this example, the CPU 16 detects whether a sparse dot pattern is present in the blue-colored image 7 during decomposition, by a filling technique. If, as a result of this detection process, it decides that a sparse dot pattern is present, the CPU 16 reports this as a decision of detection of forgery.

Regarding whether a sparse dot pattern is present or not, for example the decision may be made by comparing a basic pattern of sparse dots stored beforehand in the memory 13 with the pattern of the image and identifying forgery as when the patterns mutually coincide or are closely similar. It should be noted that the background is not necessarily blue in color and it could be arranged to detect whether a sparse dot pattern is present or not in each of the blue colored image 72, red colored image 73 and green colored image 74 obtained by separation.

With this example of application, a sparse dot pattern can be detected by a filling technique, so, compared with the Fourier transformation described above, the amount of calculation involved is small, and appraisal of genuineness can be executed rapidly.

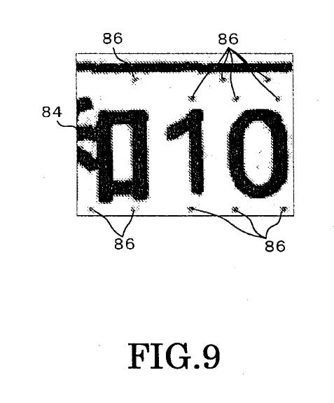

Next, another embodiment of a personal identification document genuineness appraisal apparatus will be described with reference to FIG. 8 and FIG. 9. In this other embodiment, the background color of the color image of the license 2 where no letter or photograph is printed is made use of. The background of the license 2 is of a color that is substantially white but slightly tinged with yellow.

Consequently, when, in order to forge a license 2, a license 2 is scanned by a scanner and printed using a color printer, in attempting to produce this very slight yellow color, the color printer prints sparse yellow dots 85 in the background portion of the image 81, as shown in FIG. 8.

Thus, when the forged license in which these yellow dots 85 are present is read by scanning using the scanner 3, the CPU 16 extracts an image including the preset background from the color image read by the scanner 3 and separates a blue image of the blue component, and red image of the red component and a green image of the green component from the image including the background that has thus been extracted.

In the image, of the color-separated images obtained in this way, of color approximating to the background color, for example, the blue image 84 as shown in FIG. 9, a pattern of sparse dots 86 appears in locations (background portion) where there are no characters.

If such a pattern of sparse dots 86 appears, the CPU 16 concludes that the license 2 that has been read by the scanner 3 is a forgery printed using a color printer i.e. is a “forged license”. This method can be widely applied to personal identification documents whose background is not perfectly white.

According to these embodiments, the genuineness of a personal identification document can be readily appraised by an inexpensive construction using a computer and scanner.

It should be noted that this technique is not restricted to the above embodiments and in the implementation stage its constituent elements could be modified within a range that does not depart from the gist thereof.

For example, although, in the above embodiments, Moiré stripes were detected from the blue colored background portion of the photograph of the license 2, apart from this, the “validity term” column of the license 2 is a monochromatic filled region (gold colored, blue colored or bright green colored), so it could be arranged for Moiré stripes to be detected in this portion also.

Also, for example the various constituent elements could be implemented by a program installed on storage such as a hard disk device of the computer, or the above program could be stored on computer-readable electronic media, or the functionality of the present invention could be arranged to be implemented by computer by having the computer read the program from electronic media. The electronic media may include for example storage media such as a CD-ROM or flash memory, or removable media. In addition, it could be implemented by storing the constituent elements in dispersed fashion on different computers connected to a network, and communicating between computers functioning as respective constituent elements.

In addition, in addition to Japanese driving licenses etc, this technique could of course be applied to any type of card used in the world, so long as it has lines (or surfaces) displayed with some color other than white/black.

While certain embodiments have been described, these embodiments have been presented by way of example only, and are not intended to limit the scope of the inventions. Indeed, the novel embodiments described herein may be embodied in a variety of other forms: furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An apparatus for appraising the genuineness of personal identification documents comprising:
an image reading section that reads an image of a personal identification document;
an extraction section that extracts a monochromatic filled region from said image read by said image reading section; and
a decision section that decides that said personal identification document is forged if a specified image pattern is present in said monochromatic filled region extracted by said extraction section, and that decides that a personal identification document is not forged i.e. is genuine if said specified image pattern is not present in said monochromatic filled region extracted by said extraction section.

2. An apparatus for appraising the genuineness of personal identification documents comprising:
an image reading section that reads an image of a personal identification document;
an extraction section that extracts a monochromatic filled region from said image read by said image reading section; and
a decision section that separates said monochromatic filled region extracted by said extraction section into images of different color and that decides that said personal identification document is forged if a specified image pattern is present in an image of any one of separated colors, and that decides that said personal identification document is not forged i.e. is genuine if said specified image pattern is not present in an image of any one of said separated colors.
